(19) United States
(12) Patent Application Publication
(10) Pub. No.: US 2026/0214664 A1
(43) Pub. Date: Jul. 23, 2026

(54) METHODS AND APPARATUSES FOR WIRELESS COMMUNICATION

(71) Applicant: Telefonaktiebolaget LM Ericsson (publ), Stockholm (SE)

(72) Inventors: Haoyu LI, Beijing (CN); Huaisong ZHU, Beijing (CN); Changqing YUAN, Beijing (CN); Kunpeng QI, Shanghai (CN)

(21) Appl. No.: 19/143,203

(22) PCT Filed: Dec. 30, 2022
(86) PCT No.: PCT/CN2022/143890

§ 371 Date: Jun. 25, 2025

(51) Int. Cl. H04W 72/121; H04B 7/06

(52) U.S. Cl. CPC H04W 72/121; H04B 7/0626

(57) ABSTRACT

Methods and apparatuses for wireless communication are disclosed. According to an embodiment, a network node assigns a first terminal device to one of a plurality of groups, based on a channel condition reported by the first terminal device. Each of the plurality of groups corresponds to a different number of antenna branches of a radio component of the network node which are in working state for communication. The network node schedules a first transmission to the first terminal device in a transmission time interval (TTI), based on the assigned group of the first terminal device. The network node performs the first transmission to the first terminal device, based on a result of the scheduling.

### TECHNICAL FIELD

Embodiments of the disclosure generally relate to communication, and, more particularly, to methods and apparatuses for wireless communication.

### BACKGROUND

This section introduces aspects that may facilitate better understanding of the present disclosure. Accordingly, the statements of this section are to be read in this light and are not to be understood as admissions about what is in the prior art or what is not in the prior art.

Massive multiple-input multiple-output (MIMO) is a major technology in the 5th generation (5G) and future radio technology. Instead of broadcasting data throughout the entire coverage area, the massive MIMO system concentrates the signal energy to a specific user, resulting in significant improvement of throughput and efficiency. With more and more radio frequency (RF) branches are used in a base station, energy efficiency becomes more and more important.

In 5G new radio (NR), beam management plays an important role in two periods: random access channel (RACH) procedure and connection procedure. In the RACH procedure, a next generation node B (gNB) sweeps a beam by using different downlink (DL) beam for each synchronization signal block (SSB), and a UE detects the best beam from the gNB and informs the selection by using a specific physical random access channel (PRACH) resource mapped to each DL beam.

In the connection procedure, the following beam management procedures based on channel state information (CSI) measurement/report are supported. In the first phase, the gNB sweeps the beam and the UE selects a best one and reports it to the gNB. In the second phase, the gNB refines the beam (e.g., sweeping a narrower beam over a narrower range) and the UE detects the best one and reports it to the gNB. In the third phase, the gNB fixes a beam (transmits the same beam repeatedly) and the UE refines its receiver beam.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for wireless communication. In particular, one of the problems to be solved by the disclosure is that in the existing radio products, the used RF branches in one cell are fixed after the cell is setup, resulting in low energy efficiency in some cases.

According to a first aspect of the disclosure, there is provided a method performed by a network node. The method may comprise assigning a first terminal device to one of a plurality of groups, based on a channel condition reported by the first terminal device. Each of the plurality of groups may correspond to a different number of antenna branches of a radio component of the network node which are in working state for communication. The method may further comprise scheduling a first transmission to the first terminal device in a transmission time interval (TTI), based on the assigned group of the first terminal device. The method may further comprise performing the first transmission to the first terminal device, based on a result of the scheduling.

With the above first aspect, it is possible to improve the communication performance of the network node since the group division based on channel conditions of terminal devices is considered in the scheduling.

In an embodiment of the disclosure, the first transmission to the first terminal device and at least one second transmission to at least one second terminal device may be scheduled in the same TTJ. The at least one second terminal device is assigned to the same group as that of the first terminal device.

In an embodiment of the disclosure, the first transmission to the first terminal device may be performed by using the antenna branches corresponding to the assigned group of the first terminal device.

In an embodiment of the disclosure, the first transmission to the first terminal device and at least one third transmission to at least one third terminal device may be scheduled in the same TTI. The at least one third terminal device is assigned to a different group than that of the first terminal device.

In an embodiment of the disclosure, the first transmission to the first terminal device may be performed by using the antenna branches corresponding to the assigned group of the at least one third terminal device.

In an embodiment of the disclosure, performing the first transmission to the first terminal device may comprise estimating a signal to interference plus noise ratio (SINR), based on the channel condition reported by the first terminal device. Performing the first transmission to the first terminal device may further comprise converting the SINR to a target SINR corresponding to the assigned group of the at least one third terminal device. Performing the first transmission to the first terminal device may further comprise estimating a modulation and coding scheme (MCS) for the first transmission, based on the target SINR.

In an embodiment of the disclosure, information about the used antenna branches may be informed by a baseband component of the network node to the radio component.

In an embodiment of the disclosure, assigning the first terminal device to one of the plurality of groups may comprise transmitting a channel state information reference signal (CSI-RS) to the first terminal device. Assigning the first terminal device to one of the plurality of groups may further comprise receiving a channel state information (CSI) from the first terminal device. Assigning the first terminal device to one of the plurality of groups may further comprise determining, from the plurality of groups, a group for the first terminal device, based on the received CSI.

In an embodiment of the disclosure, a first CSI-RS corresponding to a first group in the plurality of groups may be transmitted to the first terminal device. When the received CSI in response to the first CSI-RS indicates a channel condition better than a first predetermined level, a second CSI-RS corresponding to a second group in the plurality of groups may be transmitted to the first terminal device. The number of antenna branches corresponding to the second group is smaller than the number of antenna branches corresponding to the first group. Additionally or alternatively, when the received CSI in response to the second CSI-RS indicates a channel condition better than a second predetermined level, the second group may be determined for the first terminal device.

In an embodiment of the disclosure, the first CSI-RS initially transmitted to the first terminal device may correspond to total antenna branches of the radio component.

In an embodiment of the disclosure, when the second group is determined for the first terminal device, the second CSI-RS in place of the first CSI-RS may be transmitted to the first terminal device.

In an embodiment of the disclosure, the method may further comprise transmitting, to the first terminal device, configurations about a plurality of CSI-RS resource sets corresponding to the plurality of groups.

According to a second aspect of the disclosure, there is provided a method performed by a terminal device. The method may comprise receiving a transmission from a network node. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device.

With the above second aspect, it is possible to improve the performance of the transmission to the terminal device.

In an embodiment of the disclosure, the method may further comprise receiving, from the network node, a first CSI-RS corresponding to a first group. The first group may correspond to a first number of antenna branches of the radio component of the network node which are in working state for communication. The method may further comprise transmitting a first CSI to the network node. The method may further comprise receiving, from the network node, a second CSI-RS corresponding to a second group. The second group may correspond to a different second number of antenna branches of the radio component of the network node which are in working state for communication. The method may further comprise transmitting a second CSI to the network node.

In an embodiment of the disclosure, the method may further comprise receiving, from the network node, configurations about a plurality of CSI-RS resource sets corresponding to the plurality of groups.

In an embodiment of the disclosure, the method may further comprise providing user data and forwarding the user data to a host computer via the transmission to the base station.

According to a third aspect of the disclosure, there is provided a network node. The network node may comprise at least one processor and at least one memory. The at least one memory may contain instructions executable by the at least one processor, whereby the network node may be operative to assign a first terminal device to one of a plurality of groups, based on a channel condition reported by the first terminal device. Each of the plurality of groups may correspond to a different number of antenna branches of a radio component of the network node which are in working state for communication. The network node may be further operative to schedule a first transmission to the first terminal device in a TTI, based on the assigned group of the first terminal device. The network node may be further operative to perform the first transmission to the first terminal device, based on a result of the scheduling.

In an embodiment of the disclosure, the network node may be operative to perform the method according to the above first aspect.

According to a fourth aspect of the disclosure, there is provided a terminal device. The terminal device may comprise at least one processor and at least one memory. The at least one memory may contain instructions executable by the at least one processor, whereby the terminal device may be operative to receive a transmission from a network node. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device.

In an embodiment of the disclosure, the terminal device may be operative to perform the method according to the above second aspect.

According to a fifth aspect of the disclosure, there is provided a computer program product. The computer program product may contain instructions which when executed by at least one processor, cause the at least one processor to perform the method according to any of the above first and second aspects.

According to a sixth aspect of the disclosure, there is provided a computer readable storage medium. The computer readable storage medium may store thereon instructions which when executed by at least one processor, cause the at least one processor to perform the method according to any of the above first and second aspects.

According to a seventh aspect of the disclosure, there is provided a network node. The network node may comprise an assigning module for assigning a first terminal device to one of a plurality of groups, based on a channel condition reported by the first terminal device. Each of the plurality of groups may correspond to a different number of antenna branches of a radio component of the network node which are in working state for communication. The network node may further comprise a scheduling module for scheduling a first transmission to the first terminal device in a TTI, based on the assigned group of the first terminal device. The network node may further comprise a transmission module for performing the first transmission to the first terminal device, based on a result of the scheduling.

According to an eighth aspect of the disclosure, there is provided a terminal device. The terminal device may comprise a reception module for receiving a transmission from a network node. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device.

According to a ninth aspect of the disclosure, there is provided a method implemented in a communication system including a network node and a terminal device. The method may comprise all steps of the methods according to the above first and second aspects.

According to a tenth aspect of the disclosure, there is provided a communication system. The communication system may comprise a network node according to the above third or seventh aspect and a terminal device according to the above fourth or eighth aspect.

With some embodiment(s) of the disclosure, the transmission power of a network node such as a base station can be saved by turning off some antenna branches for the TTI, e.g. when the scheduled terminal devices are near to the network node. Meanwhile, the cell coverage and traffic performance may be not impacted.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating an architecture of a gNB;

FIG. 2 is a flowchart illustrating a method performed by a network node according to an embodiment of the disclosure;

FIG. 3 is a flowchart for explaining the method of FIG. 2;

FIG. 4 is a flowchart for explaining the method of FIG. 2;

FIG. 5 is a flowchart illustrating a method performed by a network node according to an embodiment of the disclosure;

FIG. 6 is a flowchart illustrating a method performed by a terminal device according to an embodiment of the disclosure;

FIGS. 7A-7B are flowcharts each illustrating a method performed by a terminal device according to an embodiment of the disclosure;

FIG. 8 is a block diagram showing an apparatus suitable for use in practicing some embodiments of the disclosure;

FIG. 9 is a block diagram showing a network node according to an embodiment of the disclosure;

FIG. 10 is a block diagram showing a terminal device according to an embodiment of the disclosure;

FIG. 11 is a block diagram illustrating an exemplary base station according to an embodiment of the disclosure;

FIG. 12 is a flowchart illustrating an exemplary process according to an embodiment of the disclosure;

FIG. 13 is diagram illustrating an example of a communication system in accordance with some embodiments;

FIG. 14 is a diagram illustrating a UE in accordance with some embodiments;

FIG. 15 is a diagram illustrating a network node in accordance with some embodiments;

FIG. 16 is a diagram illustrating a host in accordance with some embodiments;

FIG. 17 is a diagram illustrating a virtualization environment in which functions implemented by some embodiments may be virtualized;

FIG. 18 is a diagram illustrating a host communicating via a network node with a UE over a partially wireless connection in accordance with some embodiments;

FIG. 19 is a flowchart illustrating a method implemented in a communication system in accordance with some embodiments;

FIG. 20 is a flowchart illustrating a method implemented in a communication system in accordance with some embodiments;

FIG. 21 is a flowchart illustrating a method implemented in a communication system in accordance with some embodiments; and

FIG. 22 is a flowchart illustrating a method implemented in a communication system in accordance with some embodiments.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

In general, a CSI reference signal (CSI-RS) can be configured for aperiodic, periodic, or semi-persistent transmission. In the case of aperiodic CSI-RS transmission, no periodicity is configured. Rather, a device is explicitly informed (“triggered”) about each CSI-RS transmission instant by means of signaling in downlink control information (DCI).

In the case of periodic CSI-RS transmission, a device can assume that a configured CSI-RS transmission occurs every Nth slot, where N ranges from as low as 4 (that is, CSI-RS transmissions occurs every 4th slot), to as high as 640 (that is, CSI-RS transmission occurs only every 640th slot).

In the case of semi-persistent CSI-RS transmission, a certain CSI-RS periodicity and corresponding slot offset are configured in the same way as for periodic CSI-RS transmission. However, the actual CSI-RS transmission can be activated or deactivated based on medium access control (MAC) control elements (CEs). Once the CSI-RS transmission has been activated, the device can assume that the CSI-RS transmission will continue according to the configured periodicity until it is explicitly deactivated. Similarly, once the CSI-RS transmission has been deactivated, the device can assume that there will be no CSI-RS transmissions according to the configuration until it is explicitly re-activated. It is also based on DCI signaling.

The UE measures the CSI-RS and reports CSI to the gNB. The reported CSI may include one or several of following parameters: channel resource selection indicator (CRI) indicating which beam is selected; channel quality indicator (CQI); rank indicator (RI); and precoding matrix indicator (PMI).

In NR, for traffic beams, there are two main types of beamforming: reciprocity based beamforming (sounding reference signals (SRS) based beamforming) and codebook based beamforming. In the reciprocity based beamforming, the UE transmits SRSs and the gNB performs channel estimations in order to define what direction to use, how many beams to use and which shape to use. In the codebook based beamforming, the gNB transmits CSI-RS and the UE is able to monitor consistently the given pattern of CSI-RS and thus reports CSI which may include CRI, CQI, RI and PMI. The gNB's downlink beamforming is based on the CSI and standardized precoding tables. The SRS based beamforming can only be used for time division duplex (TDD), and the codebook based beamforming can be used for both TDD and frequency division duplex (FDD).

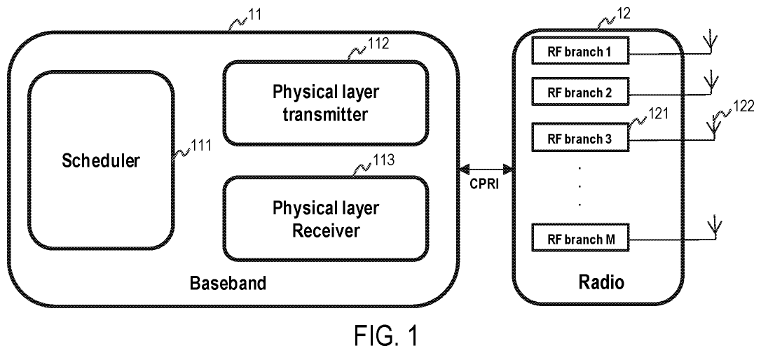

FIG. 1 illustrates the architecture of a gNB for 5G NR. As shown, the gNB includes a baseband component 11 and a radio component 12. The baseband component 11 may include, but not limited to, a scheduler 111, a physical layer transmitter 112 and a physical layer receiver 113. There may be many RF branches 121 and corresponding antenna elements 122 in the radio component 12. Each RF branch 121 has its independent power amplifier (PA). In recent years, the physical layer in some gNB products is divided into physical high layer and physical lower layer. The physical high layer is located in the baseband component, but the physical lower layer is located in the radio component.

The following is part of the functionalities of the scheduler: determining which UEs are scheduled in a TTI; estimating the beam direction; link adaption (e.g. calculating the encoding rate and modulation scheme). The UE measures the CSI-RS and estimates CQI, then reports the CQI to the gNB. Usually, the link adaption functionality estimates the signal to interference plus noise ratio (SINR) that the UE demodulates the data, based on the CQI and acknowledgment/non-acknowledgment (ACK/NACK). The modulation and coding scheme (MCS) is estimated according to the SINR.

In the current radio products, the used RF branches in one cell are fixed after the cell is setup, even all the scheduled UEs in one TTI are near to the base station. This would result in low energy efficiency of the base station.

The present disclosure proposes an improved solution for wireless communication. The solution may be applicable to a communication system including a terminal device and a network node (e.g. a base station). The terminal device can communicate through a radio access communication link with the base station. The base station can provide radio access communication links to terminal devices that are within its communication service cell. Note that the communications may be performed between the terminal device and the base station according to any suitable communication standards and protocols.

The term terminal device may also be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, the terminal device may represent a machine or other device that performs monitoring and/or measurements, and transmits the results of such monitoring and/or measurements to another terminal device and/or a network equipment. In this case, the terminal device may be a machine-to-machine (M2M) device, which may, in a 3rd generation partnership project (3GPP) context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

The term “base station (BS)” may refer to, for example, a node B (NodeB or NB), an evolved Node B (eNodeB or eNB), a next generation Node B (gNodeB or gNB), a multi-standard radio (MSR) radio node such as an MSR BS, a master eNodeB (MeNB), a secondary eNodeB (SeNB), an integrated access backhaul (IAB) node, an access point (AP), a transmission point, a transmission reception point (TRP), a remote radio unit (RRU), a radio header (RH), a remote radio head (RRH), a relay, a low power node such as a femto, a pico, and so forth. For example, a base station may comprise a central unit (CU) and one or more distributed units (DUs). The CU and DU(s) may co-locate in a same network node, e.g. a same base station.

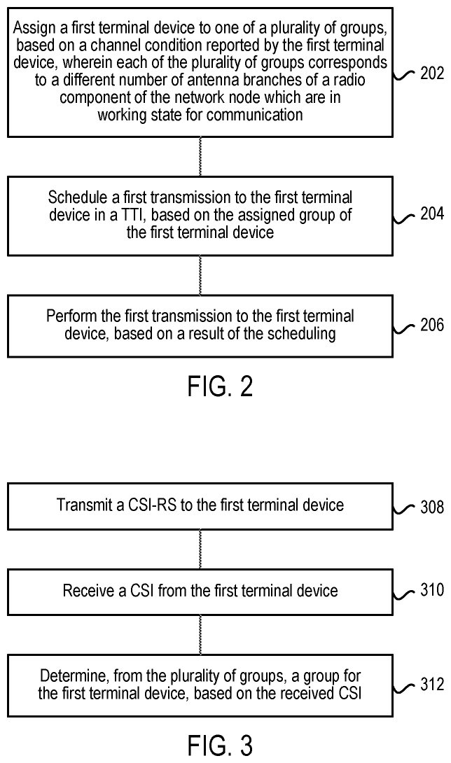

Hereinafter, the solution of the present disclosure will be described in detail with reference to FIGS. 2-22. FIG. 2 is a flowchart illustrating a method performed by a network node according to an embodiment of the disclosure. At block 202, the network node assigns a first terminal device to one of a plurality of groups, based on a channel condition reported by the first terminal device. Each of the plurality of groups corresponds to a different number of antenna branches of a radio component of the network node which are in working state for communication. For example, the channel condition may be represented in the form of a CSI which is obtained by measuring a CSI-RS by the first terminal device. Each antenna branch (or RF branch) has its independent power amplifier (PA) and may correspond to one or more antenna elements. In contrast to the antenna branches in working state, the antenna branches in non-working state refer to the antenna branches which are turned off.

For instance, the plurality of groups may comprise a total-branches group corresponding to the total antenna branches of the radio component, and one or more partial-branches group each corresponding to a different number of antenna branches of the radio component, where the different number is smaller than the number of the total antenna branches. Suppose that the number of the total antenna branches is M. As an exemplary example, there may be two groups, one of which corresponds to M branches of the radio component and the other of which corresponds to M/2 antenna branches of the radio component. As another exemplary example, there may be three groups: a first group corresponding to M branches of the radio component, a second group corresponding to M/2 antenna branches of the radio component and a third group corresponding to M/4 antenna branches of the radio component. Note that the relation between different groups is not limited to the above relation that one group is one half of another group, and any other suitable group division is possible depending on the specific application scenario.

For example, block 202 may be implemented as including blocks 308-312 of FIG. 3. At block 308, the network node transmits a CSI-RS to the first terminal device. At block 310, the network node receives a CSI from the first terminal device. At block 312, the network node determines, from the plurality of groups, a group for the first terminal device, based on the received CSI.

To ensure the communication performance, a first CSI-RS corresponding to the total-branches group (i.e. corresponding to the total antenna branches of the radio component of the network node) may be transmitted to the first terminal device initially (e.g. when the first terminal device is attached to the network node). This may be deemed as the first terminal device being assigned to the total-branches group initially. At this time, the total-branches group may be called as the first group for ease of explanation. When the received CSI in response to the first CSI-RS indicates a channel condition better than a first predetermined level (corresponding to the first group), a second CSI-RS corresponding to a second group in the plurality of groups may be transmitted to the first terminal device, where the number of antenna branches corresponding to the second group is smaller than the number of antenna branches corresponding to the first group. This may be deemed as the second group being preliminarily determined for the first terminal device at block 312. In the above exemplary example of two groups, the second group is the M/2-branches group. In the above exemplary example of three groups, the second group may be the M/2-branches group. Note that if the received CSI in response to the first CSI-RS indicates a channel condition not better than the first predetermined level, the first group may be determined as the assigned group for the first terminal device.

When the received CSI in response to the second CSI-RS indicates a channel condition better than a second predetermined level (corresponding to the second group), the second group may be determined for the first terminal device as the assigned group. Since the first terminal device is assigned to the second group, the second CSI-RS in place of the first CSI-RS may be transmitted to the first terminal device. During the time period in which the first and second CSI-RSs are both transmitted, the first terminal device can measure both CSI-RSs and report CSIs for both CSI-RSs to the network node. In this way, if a transmission to the first terminal device is needed during this time period, a suitable beam corresponding to the assigned group (which may be either the first group or the second group) can be generated for the first terminal device based on the corresponding CSI (e.g. the CRI contained therein). Note that if the received CSI in response to the second CSI-RS indicates a channel condition not better than the second predetermined level, the first group may be determined as the assigned group for the first terminal device.

If there is a further group that has not been considered for the assigning process, the second CSI-RS can be taken (or deemed) as a new first CSI-RS and the above described process may be performed again, so that a suitable group can be finally determined for the first terminal device. For instance, in the above exemplary example of three groups, if the received CSI in response to the new first CSI-RS (corresponding to the M/2-branches group) indicates a channel condition better than the new first predetermined level (corresponding to the M/2-branches group), a new second CSI-RS corresponding to the new second group (i.e. the M/4-branches group) may be transmitted to the first terminal device. If the received CSI in response to the new second CSI-RS indicates a channel condition better than the new second predetermined level (corresponding to the M/4-branches group), the new second group (i.e. the M/4-branches group) may be determined for the first terminal device as the assigned group.

At block 204, the network node schedules a first transmission to the first terminal device in a TTI, based on the assigned group of the first terminal device. At block 206, the network node performs the first transmission to the first terminal device, based on a result of the scheduling. As a first option, the first transmission to the first terminal device and at least one second transmission to at least one second terminal device that is assigned to the same group as that of the first terminal device are scheduled in the same TTI. The first transmission to the first terminal device is performed by using the antenna branches corresponding to the assigned group of the first terminal device. Information about the used antenna branches is informed by a baseband component of the network node to the radio component. A new interface may be introduced for this purpose. Correspondingly, the radio component can be configured to operate the used antenna branches indicated in the information and turn off the unused antenna branches if there are any unused antenna branches. With the first option, those terminal devices which are near to the network node and thus are assigned to the same partial-branches group can be scheduled in the same TTI. Further, the transmissions to these terminal devices in this same TTI can be performed by using only a part of the total antenna branches thereby improving the energy efficiency of the network node without impacting the cell coverage and traffic performance. Note that the TTIs scheduled for different groups may be arranged in any suitable order.

The above first option may be the general case. As a second option, the first transmission to the first terminal device and at least one third transmission to at least one third terminal device that is assigned to a different group than that of the first terminal device are scheduled in the same TTI. The second option is applicable to the case where the first transmission has to be started immediately, e.g. the first transmission has a higher requirement on latency. For the second option, the first transmission to the first terminal device is performed by using the antenna branches corresponding to the assigned group of the at least one third terminal device. Similarly to the above first option, information about the used antenna branches may be informed by the baseband component of the network node to the radio component. Correspondingly, the radio component can be configured to operate the used antenna branches indicated in the information and turn off the unused antenna branches if there are any unused antenna branches.

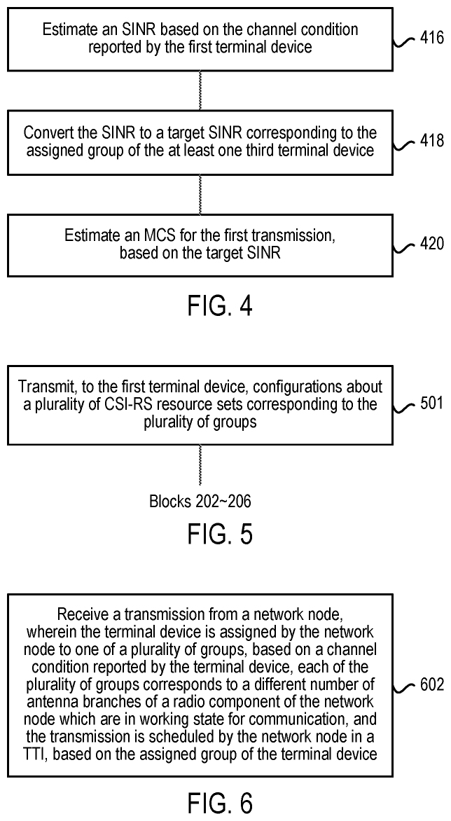

Since the CSI reported by the first terminal device is based on a different CSI-RS than that for the at least one third terminal device, block 206 for the second option is implemented as including blocks 416-420 of FIG. 4. At block 416, the network node estimates an SINR, based on the channel condition reported by the first terminal device. For instance, the SINR may be estimated based on the CSI-RS corresponding to the assigned group of the first terminal device. At block 418, the network node converts the SINR to a target SINR corresponding to the assigned group of the at least one third terminal device. If the number of the antenna branches corresponding to the assigned group of the first terminal device is smaller than the number of the antenna branches corresponding to the assigned group of the at least one third terminal device, a first predetermined delta value may be added to the estimated SINR to obtain the target SINR. On the other hand, if the number of the antenna branches corresponding to the assigned group of the first terminal device is larger than the number of the antenna branches corresponding to the assigned group of the at least one third terminal device, a second predetermined delta value may be subtracted from the estimated SINR to obtain the target SINR. The first and second predetermined delta values may be obtained through actual experiments or computer simulations. As an exemplary example, the first predetermined delta value may be equal to the second predetermined delta value. At block 420, the network node estimates an MCS for the first transmission, based on the target SINR.

Based on the above description, with the method of FIG. 2, it is possible to improve the communication performance (e.g. about the energy efficiency or communication latency) of the network node since the group division based on channel conditions of terminal devices is considered in the scheduling.

FIG. 5 is a flowchart illustrating a method performed by a network node according to an embodiment of the disclosure. As shown, the method comprises block 501 and blocks 202-206 described above. At block 501, the network node transmits, to the first terminal device, configurations about a plurality of CSI-RS resource sets corresponding to the plurality of groups. In this way, when a CSI-RS corresponding to a group is necessary for the first terminal device, the network node can transmit a signaling (e.g. a MAC CE) to the first terminal device to activate the reception of the corresponding CSI-RS by the first terminal device. Blocks 202-206 have been described above and their details are omitted here for brevity.

FIG. 6 is a flowchart illustrating a method performed by a terminal device according to an embodiment of the disclosure. At block 602, the terminal device receives a transmission from a network node. The terminal device is assigned by the network node to one of a plurality of groups, based on a channel condition reported by the terminal device. Each of the plurality of groups corresponds to a different number of antenna branches of a radio component of the network node which are in working state for communication. The transmission is scheduled by the network node in a TTI, based on the assigned group of the terminal device. The details about the assigning process and the scheduling process have been described above and thus are omitted here. With the method of FIG. 6, it is possible to improve the performance (e.g. about energy efficiency or communication latency) of the transmission to the terminal device.

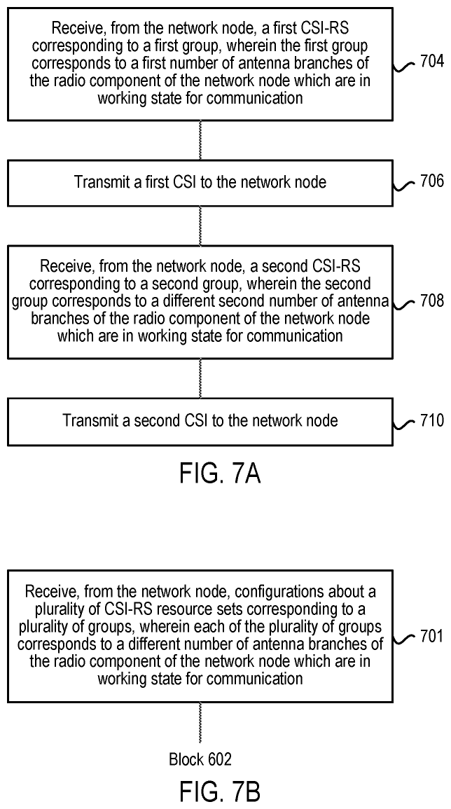

FIG. 7A is a flowchart illustrating a method performed by a terminal device according to an embodiment of the disclosure. At block 704, the terminal device receives, from a network node, a first CSI-RS corresponding to a first group. The first group corresponds to a first number of antenna branches of the radio component of the network node which are in working state for communication. At block 706, the terminal device transmits a first CSI to the network node. At block 708, the terminal device receives, from the network node, a second CSI-RS corresponding to a second group. The second group corresponds to a different second number of antenna branches of the radio component of the network node which are in working state for communication. At block 710, the terminal device transmits a second CSI to the network node. With the method of FIG. 7A, it is possible for the terminal device to support the network node to determine a suitable group for the terminal device.

FIG. 7B is a flowchart illustrating a method performed by a terminal device according to an embodiment of the disclosure. As shown, the method comprises block 701, and block 602 described above. At block 701, the terminal device receives, from the network node, configurations about a plurality of CSI-RS resource sets corresponding to the plurality of groups. In this way, when a CSI-RS corresponding to a group is necessary for the terminal device, the reception of the corresponding CSI-RS by the first terminal device can be activated by e.g. receiving a signaling (e.g. a MAC CE) from the network node. Block 602 has been described above and its details are omitted here.

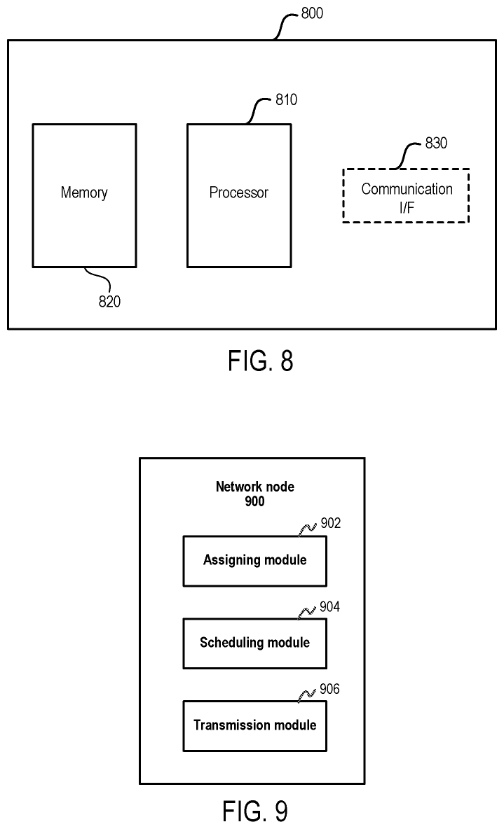

FIG. 8 is a block diagram showing an apparatus suitable for use in practicing some embodiments of the disclosure. For example, any one of the network node and the terminal device described above may be implemented through the apparatus 800. As shown, the apparatus 800 may include a processor 810, a memory 820 that stores a program, and optionally a communication interface 830 for communicating data with other external devices through wired and/or wireless communication.

The program includes program instructions that, when executed by the processor 810, enable the apparatus 800 to operate in accordance with the embodiments of the present disclosure, as discussed above. That is, the embodiments of the present disclosure may be implemented at least in part by computer software executable by the processor 810, or by hardware, or by a combination of software and hardware.

The memory 820 may be of any type suitable to the local technical environment and may be implemented using any suitable data storage technology, such as semiconductor based memory devices, flash memories, magnetic memory devices and systems, optical memory devices and systems, fixed memories and removable memories. The processor 810 may be of any type suitable to the local technical environment, and may include one or more of general purpose computers, special purpose computers, microprocessors, digital signal processors (DSPs) and processors based on multi-core processor architectures, as non-limiting examples.

FIG. 9 is a block diagram showing a network node according to an embodiment of the disclosure. As shown, the network node 900 comprises an assigning module 902, a scheduling module 904 and a transmission module 906. The assigning module 902 may be configured to assign a first terminal device to one of a plurality of groups, based on a channel condition reported by the first terminal device, as described above with respect to block 202. Each of the plurality of groups may correspond to a different number of antenna branches of a radio component of the network node which are in working state for communication. The scheduling module 904 may be configured to schedule a first transmission to the first terminal device in a TTI, based on the assigned group of the first terminal device, as described above with respect to block 204. The transmission module 906 may be configured to perform the first transmission to the first terminal device, based on a result of the scheduling, as described above with respect to block 206.

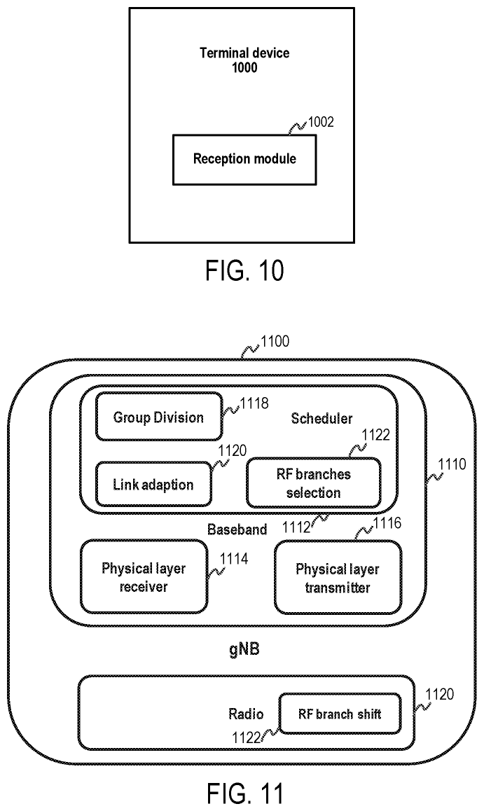

FIG. 10 is a block diagram showing a terminal device according to an embodiment of the disclosure. As shown, the terminal device 1000 comprises a reception module 1002. The reception module 1002 may be configured to receive a transmission from a network node, as described above with respect to block 602. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device. The modules described above may be implemented by hardware, or software, or a combination of both.

FIG. 11 is a block diagram illustrating an exemplary base station according to an embodiment of the disclosure. In this embodiment, the base station may be e.g. a gNB for 5G NR. In a massive MIMO telecommunication system, there are generally many RF branches in a base station. Suppose that the base station supports M RF branches (or antenna branches) each of which has its own PA.

Suppose that one cell is set up with the M RF branches. When the M RF branches are used, the cell coverage is guaranteed. In NR, synchronization signal block (SSB) is broadcast in the cell and should be transmitted with the M RF branches to ensure the cell coverage. SSB includes primary synchronization signal (PSS), secondary synchronization signal (SSS) and physical broadcast channel (PBCH). Physical downlink control channel (PDCCH) in common search space should be transmitted with the M RF branches to ensure the cell coverage, too.

To save the power of the base station, when all the scheduled UEs in a TTI is near to the base station, less base station (BS) transmission RF branches are used for transmission, and the PAs of the unused RF branches are turned off to save power. To achieve this, two new modules are introduced in the scheduler 1112 of the baseband component 1110 of the base station 1100: a group division module 1118, and an RF branches selection module 1122. In the radio component 1120, a new module (i.e. an RF branch shift module 1120) is introduced. As also shown in FIG. 11, the scheduler 1112 further has a link adaptation module 1120. The baseband component 1110 further has a physical layer receiver 1114 and a physical layer transmitter 1116. Now, the newly introduced enhancements will be described in detail respectively.

### Group Division Module

As mentioned above, the base station have M RF branches. In the initial configuration, several groups are defined: e.g. operation with N₁ branches, operation with N₂ branches, . . . , operation with Nₖ branches, and operation with M branches, where N₁, N₂, . . . , Nₖ are positive integers but less than M.

The attached UEs in the cell are allocated to the above groups according to their channel conditions. For convenience of description, only two groups are described below: operation with N branches, and operation with M branches, where N may be one of N₁, N₂, . . . , Nₖ and is less than M.

When a UE is attached, the UE is configured with two CSI-RS resource sets via 3GPP radio resource control (RRC) reconfiguration message. One CSI-RS resource set is mapped to ‘N’ RF branches, and the other is mapped to ‘M’ RF branches. The UEs with good channel condition may be allocated to ‘N’ RF branches.

In the beginning, this UE is assigned to ‘M branches group’, M RF branches are used for data transmission, and CSI-RS resource set with ‘M’ RF branches is activated by MAC-CE. The UE decodes the CSI-RS and reports CQI or CSI reference signal received power (CSI-RSRP) to the base station. According to the CQI, the base station estimates the SINR. If the SINR is higher than a predetermined SINR Threshold, sinrThresholdOfMbraches1, or CSI-RSRP is higher than a predetermined RSRP Threshold, rsrpThresholdOfMbraches1, the CSI-RS resource set with ‘N’ RF branches is triggered by MAC-CE. The UE decodes the new CSI-RS and reports new CQI or new CSI-RSRP to the base station. If the SINR is higher than a predetermined SINR Threshold, sinrThresholdOfNbraches1, or CSI-RSRP is higher than a predetermined RSRP Threshold, rsrpThresholdOfNbraches1, the UE is assigned to ‘N branches group’, and the CSI-RS resource set with ‘M’ RF branches is deactivated via MAC-CE.

When the UE is assigned to ‘N branches group’, the N RF branches are used for data transmission, and the CSI-RS resource set with ‘N’ RF branches is activated by MAC-CE. The UE decodes the CSI-RS and reports CQI or CSI-RSRP to the base station. According to the CQI, the base station estimates the SINR. If the SINR is lower than a predetermined SINR Threshold, sinrThresholdOfNbraches2, or CSI-RSRP is lower than a predetermined RSRP Threshold, rsrpThresholdOfNbraches2, the CSI-RS resource set with ‘M’ RF branches is triggered by MAC-CE, the UE is assigned to ‘M branches group’, and the CSI-RS resource set with ‘N’ RF branches is deactivated via MAC-CE.

### RF Branches Selection Module

In one TTI, the M branches are used in the base station if one of the following scenarios occurs: 1) SSB is scheduled in this TTI; 2) PDCCH common space is scheduled in this TTI; 3) the UE in ‘M branches group’ is scheduled in this TTI; and 4) random access response (RAR), message 4 (MSG 4), paging, system information blocks (SIBs), and other channels that shall be broadcasted in the whole cell are scheduled in this TTI.

In one TTI, the N branches are used in the base station in following scenario: all the scheduled UEs in this TTI are in ‘N branches group’. When the N branches are used in a certain TTI, the other unused RF branches are turned off.

In a TTI, the UEs in the same group can be tried to be scheduled, so that the possibilities to transmit with the N RF branches can be increased and the unused RF branches can be turned off. That is, UEs in different Groups are scheduled in different TTIs.

Sometimes, some data is very sensitive on timing and expected to be transmitted as soon as possible. It is very helpful for the service quality if both UEs in ‘M branches group’ and UEs in ‘N branches group’ can be scheduled in the same TTI. In this scenario, if most of UEs are in ‘N branches group’, the N RF branches are used in this TTI (which may be called Case 1 hereinafter). Otherwise, the M RF branches are used in this TTI (which may be called Case 2 hereinafter). The expression of ‘most of UEs’ may refer to ‘more than X percent of UEs’, where X can be configurable. For example, X can be set as 80% or 90%.

With respect Case 1, for any UE in ‘M branches group’, the CQI measured by the UE is based on CSI-RS with M RF branches. But the N RF branches are used for the radio component of the base station in this TTI. So the link adaption module needs to be updated to support this.

Usually the link adaption module in the base station estimates the SINR according to the UE reported CQI and ACK/NACK. Then, MCS is estimated according to the SINR. Since the N RF branches are used instead of the M RF branched, the estimated SINR is adjusted with delta, deltaFromMToN, as shown below:

$$SINR in N branches = SINR in M branches - deltaSINRFromMToN ,$$

where deltaSINRFromMToN may be measured offline and stored in a database of the base station. For example, the SINR for a stationary UE may be measured in M branches scenario and N branches scenario separately. Then, the delta, deltaFromMToN, can be obtained as below:

$$deltaSINRFromMToN = SINR in M branches - SINR in N Branches .$$

In addition, since the CRI reported by this UE in the CSI indicates the selected beam corresponding to CSI-RS with M RF branches, a target beam corresponding to CSI-RS with N RF branches is estimated according to the selected beam indicated by the CRI. Then, the estimated target beam can be used in the beamforming process.

With respect to Case 2, since a few UEs in this TTI are in ‘N branches group’, M RF branches are used for the radio component of the base station. For any UE in ‘N branches group’, the CQI measured by the UE is based on the CSI-RS with N RF branches. But the M RF branches are used for the radio component of the base station in this TTI, so the link adaption module is adjusted. Since the M RF branches are used instead of the N RF branched, the estimated SINR is adjusted with the delta, deltaFromMToN, as shown below:

$$SINR in M branches = SINR in N branches + deltaFromMToN .$$

### New Interface Between the Baseband Component and the Radio Component

A new interface may be introduced between the baseband component and the radio component. Via the new interface, in each TTI, the baseband component informs the radio component of the information related to the used RF branches (e.g. the number of used RF branches, the transmit RF branches which are utilized, the transmit RF branches which are not utilized if there are such unused RF branches, etc.).

### RF Branch Shift Module

In every TTI, via the RF branch shift module, the radio component turns on/turns off corresponding transmission RF branches according to the indication message from the baseband component.

With the base station shown in FIG. 11, the transmission power of the base station can be saved by turning off unused RF branches in each TTI when all the scheduled UEs are near to the base station. And the cell coverage and traffic performance are not impacted.

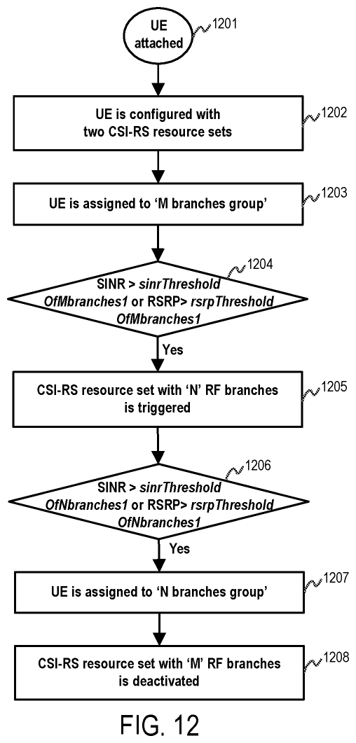

FIG. 12 is a flowchart illustrating an exemplary process according to an embodiment of the disclosure. The exemplary process may be used for the group division described above. At block 1201, the UE is attached to the cell of the base station. At block 1202, the UE is configured with two CSI-RS resource sets. At block 1203, the UE is assigned to ‘M branches group’. At block 1204, it is determined whether the SINR is higher than a predetermined SINR Threshold, sinrThresholdOfMbraches1, or CSI-RSRP is higher than a predetermined RSRP Threshold, rsrpThresholdOfMbraches1. If the determination result at block 1204 is positive, the CSI-RS resource set with ‘N’ RF branches is triggered at block 1205. At block 1206, it is determined whether the SINR is higher than a predetermined SINR Threshold, sinrThresholdOfNbraches1, or CSI-RSRP is higher than a predetermined RSRP Threshold, rsrpThresholdOfNbraches1. If the determination result at block 1206 is positive, the UE is assigned to ‘N branches group’ at block 1207. Then, at block 1208, the CSI-RS resource set with ‘M’ RF branches is deactivated.

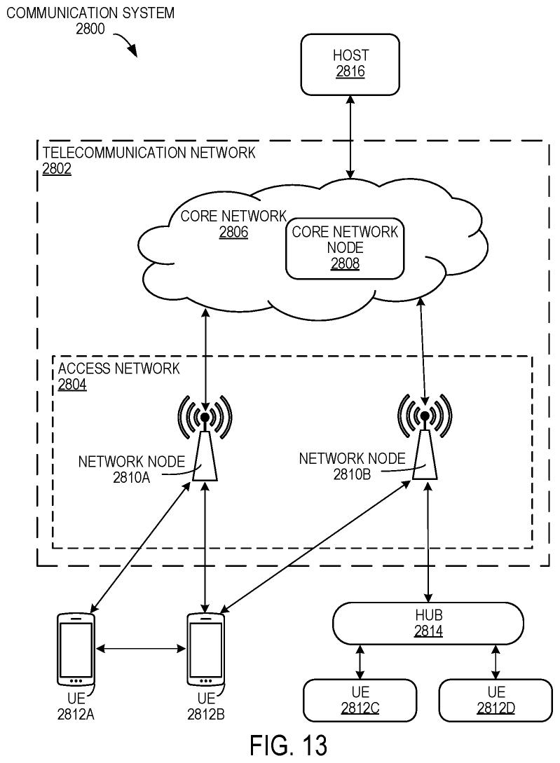

FIG. 13 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810a and 2810b (one or more of which may be generally referred to as network nodes 2810), or any other similar 3rd Generation Partnership Project (3GPP) access node or non-3GPP access point. The network nodes 2810 facilitate direct or indirect connection of user equipment (UE), such as by connecting UEs 2812a, 2812b, 2812c, and 2812d (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 2814 communicates with the access network 2804 to facilitate indirect communication between one or more UEs (e.g., UE 2812c and/or 2812d) and network nodes (e.g., network node 2810b). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810b. The hub 2814 may also allow for a different communication scheme and/or schedule between the hub 2814 and UEs (e.g., UE 2812c and/or 2812d), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810b. In other embodiments, the hub 2814 may be a non-dedicated hub—that is, a device which is capable of operating to route communications between the UEs and network node 2810b, but which is additionally capable of operating as a communication start and/or end point for certain data channels.

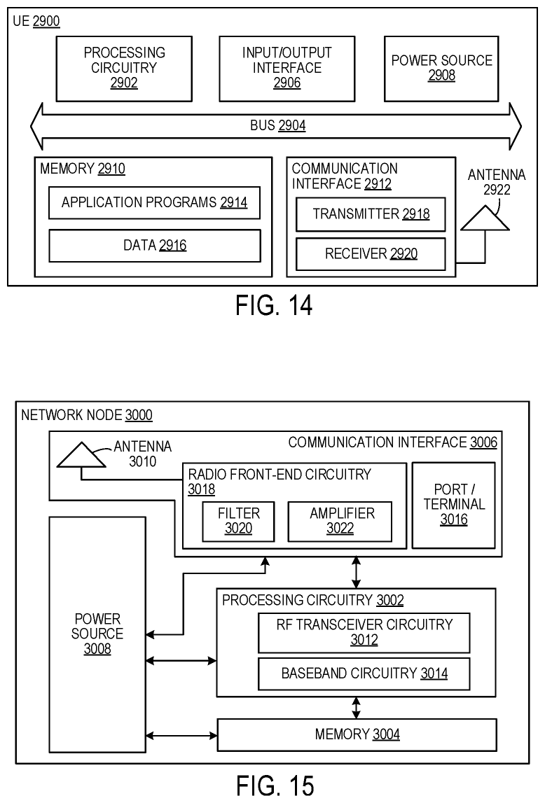

FIG. 14 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 15 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

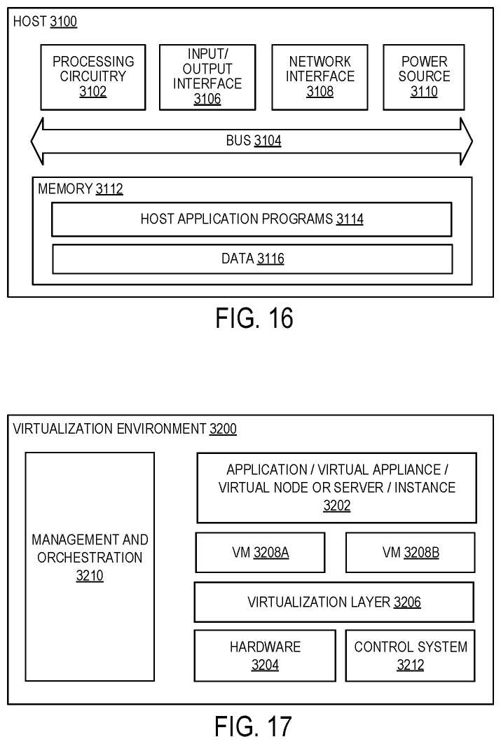

FIG. 16 is a block diagram of a host 3100, which may be an embodiment of the host 2816 of FIG. 13, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 14 and 15, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g. such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

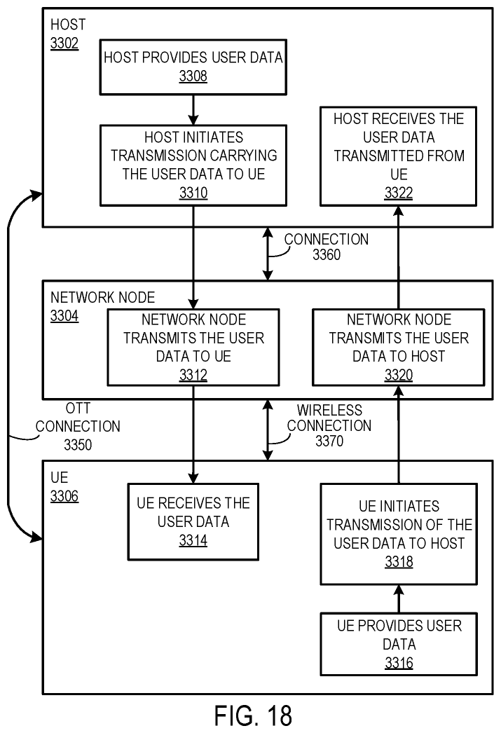

FIG. 18 shows a communication diagram of a host 3302 communicating via a network node 3304 with a UE 3306 over a partially wireless connection in accordance with some embodiments. Example implementations, in accordance with various embodiments, of the UE (such as a UE 2812a of FIG. 13 and/or UE 2900 of FIG. 14), network node (such as network node 2810a of FIG. 13 and/or network node 3000 of FIG. 15), and host (such as host 2816 of FIG. 13 and/or host 3100 of FIG. 16) discussed in the preceding paragraphs will now be described with reference to FIG. 18.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 13) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments improve the performance of OTT services provided to the UE 3306 using the OTT connection 3350, in which the wireless connection 3370 forms the last segment. More precisely, the teachings of these embodiments may save the transmission power and thereby provide benefits such as extended lifetime of base station.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

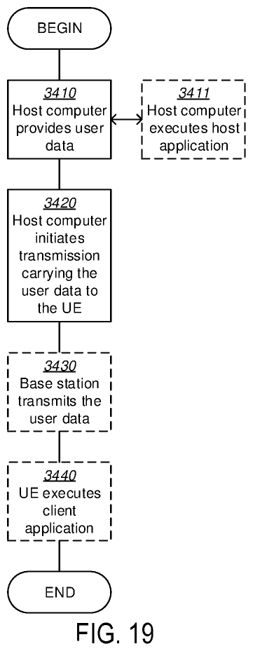

FIG. 19 is a flowchart illustrating a method implemented in a communication system, in accordance with one embodiment. The communication system includes a host computer, a base station and a UE which may be those described with reference to FIGS. 13 and 18. For simplicity of the present disclosure, only drawing references to FIG. 19 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

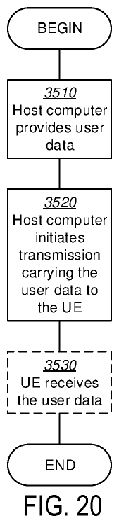

FIG. 20 is a flowchart illustrating a method implemented in a communication system, in accordance with one embodiment. The communication system includes a host computer, a base station and a UE which may be those described with reference to FIGS. 13 and 18. For simplicity of the present disclosure, only drawing references to FIG. 20 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

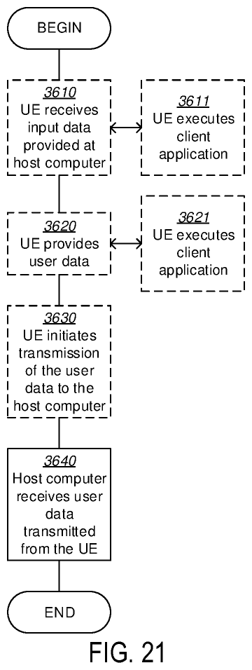

FIG. 21 is a flowchart illustrating a method implemented in a communication system, in accordance with one embodiment. The communication system includes a host computer, a base station and a UE which may be those described with reference to FIGS. 13 and 18. For simplicity of the present disclosure, only drawing references to FIG. 21 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

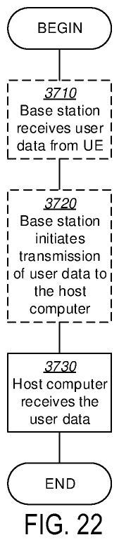

FIG. 22 is a flowchart illustrating a method implemented in a communication system, in accordance with one embodiment. The communication system includes a host computer, a base station and a UE which may be those described with reference to FIGS. 13 and 18. For simplicity of the present disclosure, only drawing references to FIG. 22 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

In an aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The base station may assign a first terminal device to one of a plurality of groups, based on a channel condition reported by the first terminal device. Each of the plurality of groups may correspond to a different number of antenna branches of a radio component of the network node which are in working state for communication. The base station may schedule a first transmission to the first terminal device in a TTI, based on the assigned group of the first terminal device. The base station may perform the first transmission to the first terminal device, based on a result of the scheduling.

In an embodiment of the disclosure, the method may further comprise, at the base station, transmitting the user data.

In an embodiment of the disclosure, the user data may be provided at the host computer by executing a host application. The method may further comprise, at the terminal device, executing a client application associated with the host application.

In another aspect of the disclosure, there is provided a communication system including a host computer comprising processing circuitry configured to provide user data and a communication interface configured to forward the user data to a cellular network for transmission to a terminal device. The cellular network may comprise a base station having a radio interface and processing circuitry. The base station's processing circuitry may be configured to assign a first terminal device to one of a plurality of groups, based on a channel condition reported by the first terminal device. Each of the plurality of groups may correspond to a different number of antenna branches of a radio component of the network node which are in working state for communication. The base station's processing circuitry may be configured to schedule a first transmission to the first terminal device in a TTI, based on the assigned group of the first terminal device. The base station's processing circuitry may be configured to perform the first transmission to the first terminal device, based on a result of the scheduling.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application, thereby providing the user data. The terminal device may comprise processing circuitry configured to execute a client application associated with the host application.

In yet another aspect of the disclosure, there is provided a method implemented in a communication system including a host computer, a base station and a terminal device. The method may comprise, at the host computer, providing user data. The method may further comprise, at the host computer, initiating a transmission carrying the user data to the terminal device via a cellular network comprising the base station. The terminal device may receive a transmission from a network node. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device.

In an embodiment of the disclosure, the method may further comprise, at the terminal device, receiving the user data from the base station.

In yet another aspect of the disclosure, there is provided a communication system including a host computer comprising processing circuitry configured to provide user data and a communication interface configured to forward user data to a cellular network for transmission to a terminal device. The terminal device may comprise a radio interface and processing circuitry. The processing circuitry of the terminal device may be configured to receive a transmission from a network node. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device.

In an embodiment of the disclosure, the communication system may further include the terminal device.

In an embodiment of the disclosure, the cellular network may further include a base station configured to communicate with the terminal device.

In an embodiment of the disclosure, the processing circuitry of the host computer may be configured to execute a host application, thereby providing the user data. The processing circuitry of the terminal device may be configured to execute a client application associated with the host application.

In yet another aspect of the disclosure, there is provided a method implemented in a communication system including a host computer, a base station and a terminal device. The method may comprise, at the host computer, receiving user data transmitted to the base station from the terminal device. The terminal device may receive a transmission from a network node. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device.

In an embodiment of the disclosure, the method may further comprise, at the terminal device, providing the user data to the base station.

In an embodiment of the disclosure, the method may further comprise, at the terminal device, executing a client application, thereby providing the user data to be transmitted. The method may further comprise, at the host computer, executing a host application associated with the client application.

In an embodiment of the disclosure, the method may further comprise, at the terminal device, executing a client application. The method may further comprise, at the terminal device, receiving input data to the client application. The input data may be provided at the host computer by executing a host application associated with the client application. The user data to be transmitted may be provided by the client application in response to the input data.

In yet another aspect of the disclosure, there is provided a communication system including a host computer comprising a communication interface configured to receive user data originating from a transmission from a terminal device to a base station. The terminal device may comprise a radio interface and processing circuitry. The processing circuitry of the terminal device may be configured to receive a transmission from a network node. The terminal device may be assigned by the network node to one of a plurality of groups, based on a channel condition reported by the terminal device. Each of the plurality of groups may correspond to a different number of antenna branches of a radio component of the network node which are in working state for communication. The transmission may be scheduled by the network node in a TTI, based on the assigned group of the terminal device.

In an embodiment of the disclosure, the communication system may further include the terminal device.

In an embodiment of the disclosure, the communication system may further include the base station. The base station may comprise a radio interface configured to communicate with the terminal device and a communication interface configured to forward to the host computer the user data carried by a transmission from the terminal device to the base station.

In an embodiment of the disclosure, the processing circuitry of the host computer may be configured to execute a host application. The processing circuitry of the terminal device may be configured to execute a client application associated with the host application, thereby providing the user data.

In an embodiment of the disclosure, the processing circuitry of the host computer may be configured to execute a host application, thereby providing request data. The processing circuitry of the terminal device may be configured to execute a client application associated with the host application, thereby providing the user data in response to the request data.

In yet another aspect of the disclosure, there is provided a method implemented in a communication system including a host computer, a base station and a terminal device. The method may comprise, at the host computer, receiving, from the base station, user data originating from a transmission which the base station has received from the terminal device. The base station may assign a first terminal device to one of a plurality of groups, based on a channel condition reported by the first terminal device. Each of the plurality of groups may correspond to a different number of antenna branches of a radio component of the network node which are in working state for communication. The base station may schedule a first transmission to the first terminal device in a TTI, based on the assigned group of the first terminal device. The base station may perform the first transmission to the first terminal device, based on a result of the scheduling.

In an embodiment of the disclosure, the method may further comprise, at the base station, receiving the user data from the terminal device.

In an embodiment of the disclosure, the method may further comprise, at the base station, initiating a transmission of the received user data to the host computer.

In yet another aspect of the disclosure, there is provided a communication system including a host computer comprising a communication interface configured to receive user data originating from a transmission from a terminal device to a base station. The base station may comprise a radio interface and processing circuitry. The base station's processing circuitry may be configured to assign a first terminal device to one of a plurality of groups, based on a channel condition reported by the first terminal device. Each of the plurality of groups may correspond to a different number of antenna branches of a radio component of the network node which are in working state for communication. The base station's processing circuitry may be configured to schedule a first transmission to the first terminal device in a TTI, based on the assigned group of the first terminal device. The base station's processing circuitry may be configured to perform the first transmission to the first terminal device, based on a result of the scheduling.

In an embodiment of the disclosure, the communication system may further include the base station.

In an embodiment of the disclosure, the communication system may further include the terminal device. The terminal device may be configured to communicate with the base station.

In an embodiment of the disclosure, the processing circuitry of the host computer may be configured to execute a host application. The terminal device may be configured to execute a client application associated with the host application, thereby providing the user data to be received by the host computer.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a network node, comprising:
assigning a first terminal device to one of a plurality of groups, based on a channel condition reported by the first terminal device, wherein each of the plurality of groups corresponding to a different number of antenna branches of a radio component of the network node which are in working state for communication;
scheduling a first transmission to the first terminal device in a transmission time interval, TTI, based on the assigned group of the first terminal device; and
performing the first transmission to the first terminal device, based on a result of the scheduling.

2. The method according to claim 1, wherein the first transmission to the first terminal device and at least one second transmission to at least one second terminal device are scheduled in a same TTI, wherein the at least one second terminal device is assigned to the same group as the first terminal device.

3. The method according to claim 1, wherein the first transmission to the first terminal device is performed by using the antenna branches corresponding to the assigned group of the first terminal device.

4. The method according to claim 1, wherein the first transmission to the first terminal device and at least one third transmission to at least one third terminal device are scheduled in the same TTI, wherein the at least one third terminal device is assigned to a different group than the first terminal device.

5. The method according to claim 4, wherein the first transmission to the first terminal device is performed by using the antenna branches corresponding to the assigned group of the at least one third terminal device.

6. The method according to claim 5, wherein performing the first transmission to the first terminal device comprises:
estimating a signal to interference plus noise ratio, SINR, based on the channel condition reported by the first terminal device;
converting the SINR to a target SINR corresponding to the assigned group of the at least one third terminal device; and
estimating a modulation and coding scheme, MCS, for the first transmission, based on the target SINR.

7. The method according to claim 3, wherein information about the used antenna branches is informed by a baseband component of the network node to the radio component.

8. The method according to claim 1, wherein assigning the first terminal device to one of the plurality of groups comprises:
transmitting a channel state information reference signal, CSI-RS, to the first terminal device;
receiving a channel state information, CSI, from the first terminal device; and
determining, from the plurality of groups, a group for the first terminal device, based on the received CSI.

9. The method according to claim 8, wherein a first CSI-RS corresponding to a first group in the plurality of groups is transmitted to the first terminal device;
wherein one or both:
when the received CSI in response to the first CSI-RS indicates a channel condition better than a first predetermined level, a second CSI-RS corresponding to a second group in the plurality of groups is transmitted to the first terminal device, wherein the number of antenna branches corresponding to the second group is smaller than the number of antenna branches corresponding to the first group; and
when the received CSI in response to the second CSI-RS indicates a channel condition better than a second predetermined level, the second group is determined for the first terminal device.

10. The method according to claim 9, wherein the first CSI-RS initially transmitted to the first terminal device corresponds to total antenna branches of the radio component.

11. The method according to claim 9, wherein when the second group is determined for the first terminal device, the second CSI-RS in place of the first CSI-RS is transmitted to the first terminal device.

12. The method according to claim 8, further comprising:
transmitting, to the first terminal device, configurations about a plurality of CSI-RS resource sets corresponding to the plurality of groups.

13. A method performed by a terminal device, the method comprising:
receiving a transmission from a network node;
the terminal device being assigned by the network node to one of a plurality of groups, based on a channel condition reported by the terminal device;
each of the plurality of groups corresponding to a different number of antenna branches of a radio component of the network node which are in working state for communication; and
the transmission being scheduled by the network node in a transmission time interval, TTI, based on the assigned group of the terminal device.

14. The method according to claim 13, further comprising:
receiving, from the network node, a first channel state information reference signal, CSI-RS, corresponding to a first group, wherein the first group corresponds to a first number of antenna branches of the radio component of the network node which are in working state for communication;
transmitting a first CSI to the network node;
receiving, from the network node, a second CSI-RS corresponding to a second group, wherein the second group corresponds to a different second number of antenna branches of the radio component of the network node which are in working state for communication; and
transmitting a second CSI to the network node.

15. The method according to claim 13, further comprising:
receiving, from the network node, configurations about a plurality of CSI-RS resource sets corresponding to the plurality of groups.

16. A network node comprising:
at least one processor; and
at least one memory, the at least one memory containing instructions executable by the at least one processor, whereby the network node is operative to:
assign a first terminal device to one of a plurality of groups, based on a channel condition reported by the first terminal device, each of the plurality of groups corresponding to a different number of antenna branches of a radio component of the network node which are in working state for communication;
schedule a first transmission to the first terminal device in a transmission time interval, TTI, based on the assigned group of the first terminal device; and
perform the first transmission to the first terminal device, based on a result of the scheduling.

17. The network node according to claim 16, wherein the first transmission to the first terminal device and at least one second transmission to at least one second terminal device are scheduled in a same TTL wherein the at least one second terminal device is assigned to the same group as the first terminal device.

18.-20. (canceled)

21. The method according to claim 2, wherein the first transmission to the first terminal device is performed by using the antenna branches corresponding to the assigned group of the first terminal device.

22. The method according to claim 5, wherein information about the used antenna branches is informed by a baseband component of the network node to the radio component.

23. The method according to claim 2, wherein assigning the first terminal device to one of the plurality of groups comprises:
transmitting a channel state information reference signal, CSI-RS, to the first terminal device;
receiving a channel state information, CSI, from the first terminal device; and
determining, from the plurality of groups, a group for the first terminal device, based on the received CSI.
